(19) United States
(12) Patent Application Publication
(10) Pub. No.: US 2018/0114005 A1
(43) Pub. Date: Apr. 26, 2018

(54) SYSTEM AND METHOD FOR MANAGING IDENTITY INFORMATION STORED IN A CLOUD SERVER

(71) Applicant: FST21 Ltd, Rishon Lezion (IL)

(72) Inventors: Ofir FRIEDMAN, Rishon Le-Zion (IL); SHAHAR BELKIN, KIBBUTZ BRUR CHAYIL (IL)

(73) Assignee: FST21 Ltd, Rishon Lezion (IL)

(21) Appl. No.: 15/559,449

(22) PCT Filed: Mar. 14, 2016
(86) PCT No.: PCT/IL2016/050279

§ 371 Date: Sep. 19, 2017

Related U.S. Application Data
(60) Provisional application No. 62/135,386, filed on Mar. 19, 2015.

(51) Int. Cl. G06F 21/32; G06F 21/88; H04L 29/06

(52) U.S. Cl. CPC G06F 21/32; G06F 21/88; H04L 63/0861; H04L 63/0884; H04L 63/102; H04L 63/0815

(57) ABSTRACT

Embodiments of the invention relate to a method and a system for managing access control identity parameters. The system includes a plurality of local access control systems configured to receive identity parameters of persons and transmit the identity parameters to a remote identity verification and management service, and to control local access controlling means. The remote identity verification and management service is configured to receive identity parameters from at least some of the plurality of local access control systems and store the identity parameters so that the identity parameters are associated with the respective persons. The remote identity verification and management service is further configured to compare the identity parameters to previously received identity parameters and credentials associated with the persons, and based on the comparison to forming an ID fused parameter vector for each of the persons and to send at least a subset of the stored ID fused parameter vector to one or more of the local access control units.

### BACKGROUND OF THE INVENTION

Access control systems, known in the art, provide various levels of security and certainty as to whether the right access permission was granted to the right person. Basic access control systems require a single identity ascertaining component, either ‘something you have’ (e.g. a key, an RFID card and the like) or ‘something you know’ (e.g. numeric code, password and the like) to be presented to the access control system in order to authorize access. In more secured systems both components may be required in order to authorize access to an access controlled location. Such systems are subject to fraud as each of the components can relatively easily be stolen, duplicated, or otherwise being misused.

Higher level of security of access control is provided by systems comprising identification of biometric parameter(s) such as face recognition, fingerprint identification, voice recognition and the like. While these systems are more immune to misuse, they suffer of several drawbacks such as the need to enroll to each access control system separately, the diversity of biometric inputs and their representation in the system, and the diversity of methods of processing the inputs. Furthermore, these systems usually lack of exchange of data and security related information between access control systems which exposes one access control system to fraudulent misuse where its level of immune could be higher should data from other access control systems has reached it.

Reference is made to FIG. 1 which schematically depicts access control systems as known in the art. Several access control units 20, 23, 26 and 28 may act, each for controlling access to its respective premises. Each of access control units 20, 23, 26 and 28 may comprise a controller, storage unit, I/O means and communication means. Each of access control units 20, 23, 26 and 28 may store identity details of persons allowed to enter (or, in some embodiments—of persons that are not allowed to enter) to the associated premises. As seen in FIG. 1 access control unit 23 may comprise more than a single access sub access control unit, for example it may comprise local sub access control units 22 and 24 that may operate in coordination with each other, may share certain data with each other and the like. For example access control unit 23 may control access to a firm that operates in two remote locations, one that is controlled by sub access control unit 22 and the other that is controlled by sub access control unit 24. As is further seen in FIG. 1 access control unit 26 that may control access to first premises, may communicate with access control unit 28 in order, for example, to share certain data items that may assist in the improvement of the performance and immunity of both access control units 26 and 28. For example access control units 26 and 28 may share identity details of persons whose access may need to be authorized by both systems.

Each access control unit may comprise one or more controlled gates/doors or other means that are configured to enable control of access to a specified location and one or more identification parameter receiving (IPR) units. An IPR unit may be or may comprise any biometric sensor known in the art, such as fingerprint reader, video/stills camera, microphone and the like. An IPR unit may further comprise non-biometric sensors or input means, such as numeric/alphanumeric keypads, magnetic/RFID card readers and the like.

### SUMMARY

Embodiments of the invention may relate to a method and a system for managing access control identity parameters. The system may include a plurality of local access control systems configured to receive identity parameters of a person and transmit the identity parameters to a remote identity verification and management service and control local access controlling means. The remote identity verification and management service may be configured to receive identity parameters from at least some of the plurality of local access control systems and store the identity parameters so that the identity parameters are associated with the person. The remote identity verification and management service may further be configured to compare the identity parameters to previously received identity parameters and credentials associated with the person and based on the comparison forming a ID fused parameter vector and send at least a subset of the stored ID fused parameter vector to one or more of the local access control units, such that the remote identity verification and management service may be adapted to send the subset of the ID fused parameter vector to the local access control system based on a pre-determined trigger and in compliance with the identity parameters competency of the local access control system.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically depicts access control systems as known in the art;

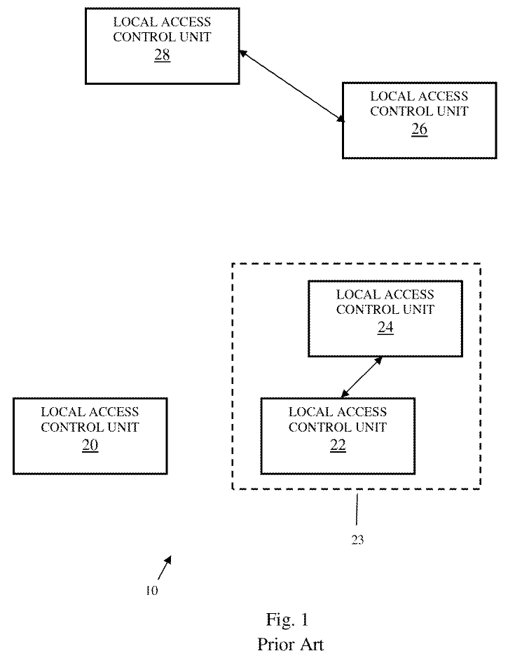

FIG. 2 schematically depicts enrollment, identity and credential (EIC) management system structured and operative according to embodiments of the present invention;

FIG. 3 is a flowchart of a method of managing access control identity parameters according to some embodiments of the invention; and

FIG. 4 is a block diagram depicting functionality of, and inter-relations between, a local access (LAC) unit and a remote cloud computing service (CCS), according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

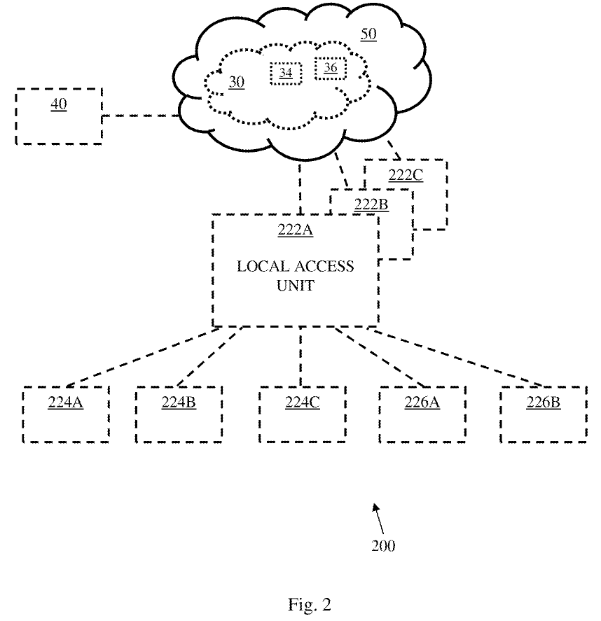

Reference is made now to FIG. 2 which schematically depicts system 200 for managing access control identity parameters according to some embodiments of the invention. System 200 may conduct enrollment, identity and credential (EIC) management and may be structured and operative according to embodiments of the present invention. System 200 may include remote identity verification and management service 30 embodied, for example, based on cloud computing means, as is known in the art. Remote management service 30 may include, or may have access to, a plurality of interconnected computing resources 34 of any kind usable in a remote and/or distributed (e.g., in a cloud computing resource) computing service, and to a plurality of storage resources 36 of any kind usable in a remote and/or distributed (e.g., a cloud) computing service. As is known with respect to remote computing services in a network, the momentary number of computing and/or storage resources that are assigned to provide computing services to system 200 may vary according to several parameters and needs. System 200 may reside in, or be in active communication with a global network 50, such as the Internet.

System 200 may be adapted to communicate with plurality of local access control systems 222A, 222B, 222C etc. Each of the local access control systems 222A, 222B and 222C may comprise, or be in active communication with several identity parameter input units such as units 224A-224C and to several access control units 226A-226B. Local access control systems 222A, 222B, 222C may be configured to receive identity parameters of a person (e.g., from units 224A-224C) and transmit the identity parameters to remote identity verification and management service 30. Local access control systems 222A, 222B, 222C may be further configured to control local access controlling units such as access control units 226A-226B.

According to some embodiments of the present invention each of the identity parameter input units 224A-224C may be used for receiving/reading/sensing one or more identity parameters of a person, such as fingerprint image, still image of the person, magnetic/optic stripe of personal ID card, RFID chip, video feed and the like. Units 224A-22C may further include any system/means for receiving such data, for example, an RFID reader, a keyboard, an magnetic card reader, a camera, a microphone, a fingerprint reader, or the like. In some embodiments, local access control systems 222A-222C may register with identity verification and management service 30 and informs it which types of credentials systems 222A-222C support, for example, the credentials of units 224A-224C.

Access control units 226A-226B may include any automatic access control systems, such as, automatic doors, turnstiles or the like. Access control units 226A-226B may include user interface that may send a security guard indication where or not to allow the access of a certain person.

System 200 may be further adapted to communicate with another identity management resource 40.

According to embodiments of the present invention ID parameters, of persons that enrolled to system 200 or otherwise provided at least one ID parameter, may be stored in storage resources 36 of remote management service 30. ID parameters may be sensed by at least one of identity parameter input units 224A-224C, and/or may be received from other access control unit or from another identity management system such as system 40. Data representing ID parameters may be in a format that is in compliance with one or more known ID parameter sensing formats. Data representing ID parameter may be coded in compliance with known coding format or formats or in compliance with proprietary codding scheme. For example a still picture of a person requesting authorization to access controlled premises may be processed according to a known face recognition method to provide a set (vector) of face characterizing data. This vector may be coded, for example in order to be protected from hostile access or attempts to change it or to take over it. Further, such ID parameter data may be compressed according to known or proprietary compression format, for example in order to enable easier, faster and/or safer transmission even over narrow-band communication channels.

In some embodiments, data and parameters to be executed by remote management service (e.g., cloud computing service (CCS)) 30 may be stored in non-transitory accessible storage resources 36 programs. Such data and parameters when executed, read and/or involved in computations made by service 30, enable performance of operations, steps and commands described in the present specification.

According to embodiments of the present invention, data representing identity parameters, authorization granted to person(s) to enter certain premises and credentials may be stored, collected, processed and fused by remote management service 30 located in the cloud. In some embodiments, based on the accumulated and fused data authorization for certain person to access certain premises may be decided: either granted or not granted by remote management service 30.

In this mode of operation identity parameters associated with certain person may be received, stored and processed in advance of a request to authorize entrance to certain premises and/or as part of the submission of the entrance request. According to embodiments of the present invention in this mode parameters associated with persons that are, or may need to be authorized to enter controlled premises through access point controlled by a local access control (LAC) unit, such as LAC system 222A. LAC system 222A be collected, stored and managed by remote management service 30. In some embodiments, LAC systems 222A-222C may be adapted to upload new identity parameters to identity verification and management service 30. In some embodiments, credential granted to a reporting person may be removed from LAC system 222A after it is used a pre-determined number of times. The pre-determined number of times may be lapsed from time it was first used. For example, credential granted for a specific person may be for a specific day may be removed from local access control unit 222A the day after and a new authorization session may be initiated when the person ask for an authorized access next time.

In some embodiments, identity parameters of a person loaded to first LAC unit 222A may be loaded to a second LAC system 222B in response to a request automatically issued when the person requests authorization to enter at the location of second local access control system 222B. Identity verification and management service 30 may control the loading of the person's identity parameters from LAC 222A to LAC 222B.

In some embodiments, personal ID parameters may be stored with the remote management service in an ordered manner, such as a matrix, allowing easy and fast access to required items in the ordered array. The ordered manner may enable fast and trustworthy verification; processing, fusing and/or updating of ID data associated with person or persons and finally providing authorization response—allowed or prohibited the person(s) to enter the certain premises. Each stored ID parameter may have, stored associated with it, additional data items, such as the ID source/input unit from which the ID parameter was received, when it was received (or when it was last authenticated), what certainty grade is associated with the unit that read/scanned and received the ID parameter, what certainty may be given to the ID parameter due to the sampling and/or coding format it was sampled/coded by, etc.

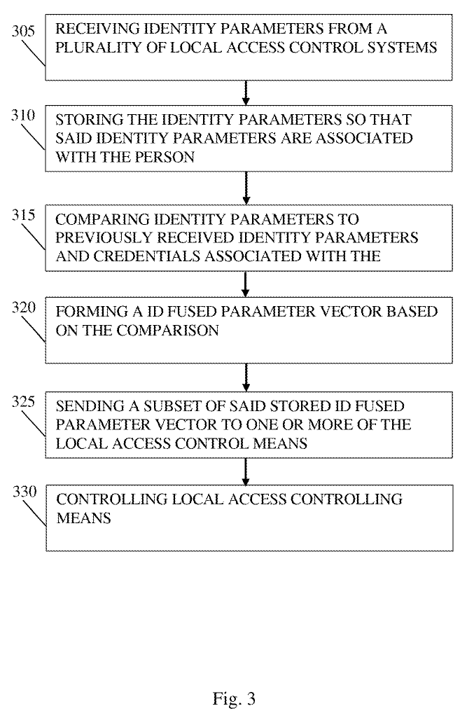

Reference is made to FIG. 3 which is a flowchart of a method of managing access control identity parameters according to some embodiments of the invention. The method of FIG. 3 may be performed by system 200 or by any other suitable system. In operation 305, the embodiments may include receiving identity parameters from a plurality of local access control systems, such as LAC systems 222A-222C. According to embodiments of the present invention ID parameters and data items representing the ID of a certain person may be received from various sources in addition to the LAC units.

According to embodiments of the present invention, in this mode of operation any LAC may receive request of a person to authorize entrance to a controlled location by means of providing personal ID parameter or parameters through ID input units (such as units 224A-224C) of that LAC unit. The ID parameter(s) and or ID data may be sent to the remote management service 30. Upon requesting to authorize an entrance the person may trigger several operations that may be executed by remote management service 30.

In operation 310, the embodiments may include storing the identity parameters so that the identity parameters are associated with a person. The identity parameters may be stored in storage resources 36 associated or in communication with remote service 30. Other identity parameters may be received from various external sources and stored in storage resources 36.

In operation 315, the embodiments may include comparing the identity parameters to previously received identity parameters and credentials associated with the person and based on the comparison forming a ID fused parameter vector. Parameters received from LAC systems such as LAC systems 222A-222C may be compared, in real-time with parameters previously received from one or more of the LACs associated with system 200 of with ID parameters received from various external sources. In some embodiments, the various sources may include external institutes such as finance institutes and the like. According to some embodiments remote management service 30 may fuse identity parameters received from the LAC and identity parameters received from the various resources these into a single ID parameter fused vector (IDPFV) that represents the ID fused data of that person.

In some embodiments, the ID parameters may be each associated with a level of trust indicating how trustworthy is the source from which the ID parameters were received? For example, ID parameters collect by a human agent during a face to face meeting may have a higher level of trust than ID parameters collected automatically, for example, from a website. ID parameters that include biometric data may have higher level of trust than ID parameters encoded on a magnetic card.

The number of parameters in the IDPFV and their interrelated weight may vary in time. For example the interrelated weight may vary due to fresh information received in the EIC system. According to embodiments of the present invention the ongoing updating info effecting the personal IDPFV may also be used to update the level of trust associated with a specific ID info source. For example, in case the updating fusion session of ID parameters continuously proves that certain ID information source, e.g. a certain LAC, receives low trust grades due to cross-comparing of various sources of ID parameters and their associated levels of trust, that source of ID information may have its level of trust been lowered for ID information of other persons. This may also apply to ID source that continuously receives high levels of trust.

In some embodiments, remote management service 30 may store in storage resources 36, the array/matrix of IDPFV for each of the persons that has enrolled to the system. Computer operable programs or codes may be stored in remote management service 30′s storage resources 36 that when executed enable operating the processes and operations of service 30 as described herein. Remote management service 30 may provide the following services in support of its operations according to embodiments of the present invention:
Enrollment management. Any request for enrollment from a person may be received by remote management service 30 computing system, recorded, evaluated, associated with trust grade and finally fused with previously stored ID parameters. Fusion of ID data may be done, for a certain person, relying only on ID data related to that person, or may take into account ID data related to other persons, if such data may reflect on the quality of the fused ID vector (IDPFV).
Identity analytics. Remote management service 30 may process ID data items stored in its storage resources 36 and or just received via any of the external units connected to remote management service 30 in order to infer on the quality of the IDPFV of the specific person. For example, if a person has sent access request from certain LAC unit and same person (by ID data) has sent access control from another LAC, where the distance between the two LACs is suspiciously too large compared with the time difference between the two requests, the current request may be considered, at least temporarily, as having low grade of trust. According to some embodiments the level of trust associated with ID data received from the other LAC may also be re-evaluated.
Identity synchronization service. Personal IDPFV vectors stored in remote management service 30 may include large number of ID parameters that may have been collected and received from a large number of sources. Some of the LAC units may require ID data that is combined, or fused, from smaller number of ID parameters. According to some embodiments some of the ID parameters that assemble the IDPFV may have tag defining them as restricted for use with association of certain types of LACs, or in association with LACs of certain premises only, or may be restricted to be disclosed or provided to certain LACs only. According to some embodiments system 200 may be requested to provide, for use during a pre-defined period of times, or pre-defined number of uses or any other limitation of use, ID data to certain LAC or LACs, for limited use. In such cases system 200 may check what are the credentials of the requesting LAC with respect to the specific requested IDPFV, in order to decide what ID data items of the specific person may be provided to the specific LAC and under what use limitations. According to some embodiments the ID data items that were provided by EIC system 200 to the specific LAC may automatically be “returned” to system 200 (meaning—be erased from the memory of the LAC and a certificate of erasure may be sent to EIC system 200).
Software development kit (SDK) for LAC units. System 200 may be configured to provide, upon proper request from a LAC, an SDK for installing, for example, on the LAC's local computation means. The SDK may include the required interface with system 200.
3^{rd} party processing (e.g., external ID sources). System 200 may further be configured to communicate with 3^{rd} party computation resources in order to receive or exchange ID-related information, for example based on pre-defined permissions and credentials.
Sensor data receipt and fusion. System 200 may be configured to communicate with any type of LAC connected to it, and to receive ID data provided with large number of formats, compression, coding and the like. For example, EIC system 200 may be configured to decode, de-compress and fuse ID data items received from any of the ID sensors connected to it.

In operation 320, the embodiments may include sending a subset of the stored ID fused parameter vector to one or more of the local access control units, such as systems 222A-222C. The fused parameter vector may include the comparison between the received identity parameters received in real time from the person asking for an authorized entrance and parameters previously stored in storage resource 36. The comparison may yield that the person is either authorized or unauthorized to enter the specific premises. In some embodiments, remote identity verification and management service 30 may be adapted to send the subset of the ID fused parameter vector to local access control system 222A based on a pre-determined trigger and in compliance with the identity parameters competency of local access control system 222A. The pre-determined trigger may include a person reporting at a controlled access point of local access control unit 222A. In some embodiments, the ID fused parameter vector may include only the identity credentials required by the local access system to allow access of the person.

In some embodiments, LAC systems 222A-222C may be configured to receive a plurality of level of trust parameters in addition to credentials, and use these parameters to determine whether to authorize access. In some embodiments, each time an ID fused parameter vector is used by LAC system (such as LAC systems 222A-222C) in order to verify access authorization a notification of the time, location, types of ID parameters and the result of the verification may be reported to remote identity verification and management service 30 and the report may be used to modify the level of trust of the credentials used and the ID fused parameter vector they associated with.

In operation 320, the embodiments may include controlling local access controlling units such as units 226A-226B to grant an entrance to the person. A turnstile may turn and allow the person to pass, an automatic door may open a security guard may allow the person to enter. In some embodiments, each time an ID fused parameter vector may be used to authorize access request in LAC, a notification of the time, location and types of credentials used is sent to remote identity verification and management service 30. In some embodiments, for each ID fused parameter vector a log file may be kept (e.g., in storage resources 36) for documenting all updates made to the vector and notifications issued with respect to the vector. In some embodiments, the log file may be kept accessible to the associated person and to person authorized to review the log file. For example, a security guard may periodically (e.g., every morning) look at the log files for any potential problems. In some embodiments, system 200 may be configured to analyze the log file and to detect anomalies automatically.

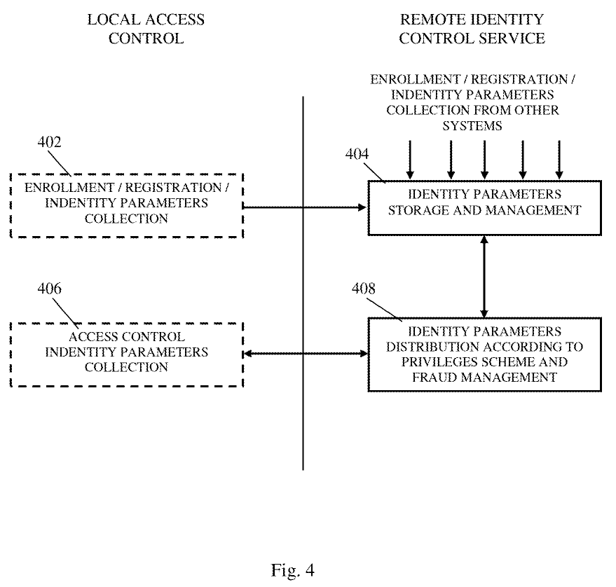

Reference is made to FIG. 4 which is a block diagram depicting functionality of, and inter-relations between, a local access (LAC) unit and a remote identity verification and management service (e.g., a cloud computing service (CCS)) such as service 30, according to embodiments of the present invention. In block 402 the LAC unit operates for receiving request to enroll to the ID services of the ID management system (such as system 200). The enrolling person may trigger enrollment session and provide the required/requested ID parameters to the remote identity verification and management service (block 404). Once enrollment process ends the enrolled person may request authorization to enter into any of the LAC units of the system and based at least on the ID parameters he/she provided during the enrollment session his/her request may be examined As seen in block 404 the remote identity verification and management service may receive and fuse ID parameters of that person from other sources (whether subject to prior consent by the person or otherwise). Following the ongoing fusion of ID information the level of authentication of the person may be updated/change. In block 408 ID information stored in storage means of the remote identity verification and management service may be provided to a LAC unit (block 406) at a request from the LAC unit or according to pre-planned update scheme. The update may be done in compliance with the level of authentication required in general at the LAC unit and in compliance with the level of trust of a specific person's ID that may be required.

In some embodiments, the process of receiving a person's request for authorization to access a location controlled by the ALC unit may be carried out completely locally after that person has enrolled to the system (e.g., system 200), except for cases where the level of authentication required for that person in that location is higher than the one set to him/her in the system currently or in cases where that person's authentication was found impaired or missing. Accordingly, in Mode I the functionality of the remote identity verification and management service may focused on collecting ID information, creating and updating ID fused vectors and providing ID parameters or an ID vector to a LAC unit when required.

In some embodiments, the actual decision whether to authorize entrance of the person to the controlled location is taken in the LAC unit. It will be noted that in this mode in response to request by a LAC unit receive updated (or new) ID fused vector the remote identity verification and management service may provide the whole available ID information (i.e. a complete ID fused vector) or a partial set of ID parameters from that vector, depending on the nature of the request, the level of required authentication, the level of authorization associated with the person, etc.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for managing access control identity parameters comprising:
a plurality of local access control systems configured to:
receive identity parameters of a person and transmit said identity parameters to a remote identity verification and management service; and
control local access controlling means; and
a remote identity verification and management service configured to:
receive identity parameters from at least some of said plurality of local access control systems;
store said identity parameters so that said identity parameters are associated with said person;
compare said identity parameters to previously received identity parameters and credentials associated with said person and based on the comparison forming a ID fused parameter vector; and
send at least a subset of said stored ID fused parameter vector to one or more of said local access control units,
wherein the remote identity verification and management service is adapted to send the subset of the ID fused parameter vector to said local access control system based on a pre-determined trigger and in compliance with the identity parameters competency of said local access control system.

2. The system of claim 1 wherein said pre-determined trigger is a person reporting at a controlled access point of said local access control systems.

3. The system of claim 2 wherein said subset of the ID fused parameter vector includes only the identity credentials required by said local access system to allow access of said person.

4. The system of claim 3 wherein each local access control system registers with the identity verification and management service and informs it which types of credentials it supports.

5. The system of claim 1 wherein the credential granted to a reporting person is removed from the local access control systems after it is used a pre-determined number of times.

6. The system of claim 1 wherein the credential granted to a reporting person is removed from the local access control system, after a pre-determined time that lapsed from time it was first used.

7. The system of claim 1 wherein local access control systems is configured to upload new identity parameters to the identity verification and management service.

8. The system of claim 7 wherein identity parameters of a person loaded to first local access control systems are loaded to a second local access control unit in response to a request automatically issued when said person requests authorization to enter at the location of said second local access control system.

9. The system of claim 1 wherein each time an ID fused parameter vector is used to authorize access request in a local access control system, a notification of the time, location and types of credentials used is sent to the remote identity verification and management service.

10. The system of claim 9, wherein for each ID fused parameter vector a log file is kept for documenting all updates made to the vector and notifications issued with respect to the vector.

11. The system from claim 10, wherein said log file is kept accessible to the associated person and to person authorized to review said log file.

12. The system of claim 10 further configured to analyze said log file and to detect anomalies.

13. The system of claim 1 wherein each ID fused parameter vector contains a plurality of ID parameters that indicate the level of trust of each credential and the overall level of trust of the ID fused parameter vector.

14. The system of claim 13 wherein a local access control system is configured to receive a plurality of level of trust parameters in addition to credentials, and use these parameters to determine whether to authorize access.

15. The system of claim 14 wherein each time a ID fused parameter vector is used by a local access control system in order to verify access authorization a notification of the time, location, types of ID parameters and the result of the verification is reported to the remote identity verification and management service and the report is used to modify the level of trust of the credentials used and the ID fused parameter vector they associated with.

16. A method of managing access control identity parameters comprising:
receiving identity parameters from a plurality of local access control systems;
storing said identity parameters so that said identity parameters are associated with a person;
comparing said identity parameters to previously received identity parameters and credentials associated with said person and based on the comparison forming a ID fused parameter vector;
sending a subset of said stored ID fused parameter vector to one or more of said local access control units; and
controlling local access controlling units,
wherein sending the subset of the ID fused parameter vector to said local access control system is based on a pre-determined trigger and in compliance with the identity parameters competency of said local access control system.

17. The method of claim 16, wherein said pre-determined trigger is a person reporting at a controlled access point of said local access control system.

18. The method of claim 16, wherein said subset of the ID fused parameter vector includes only the identity credentials required by said local access system to allow access of said person.

19. The method of claim 16, wherein each time an ID fused parameter vector is used to authorize access request in a local access control system, a notification of the time, location and types of credentials used is sent to the remote identity verification and management service.

20. The method of claim 19, wherein for each ID fused parameter vector a log file is kept for documenting all updates made to the vector and notifications issued with respect to the vector.

21. (canceled)

22. (canceled)
